(19) United States
(12) Patent Application Publication
(10) Pub. No.: US 2023/0322453 A1
(43) Pub. Date: Oct. 12, 2023

(54) NOVEL PACKAGING FOR STORAGE OF FRECKLE OR SIMILAR COSMETIC COMPOSITIONS ALONG WITH AN INTEGRATED TOOTHPICK

(71) Applicant: Brooke Hanmer, Miami, FL (US)

(72) Inventor: Brooke Hanmer, Miami, FL (US)

(21) Appl. No.: 18/209,630

(22) Filed: Jun. 14, 2023

Related U.S. Application Data
(60) Provisional application No. 63/352,325, filed on Jun. 15, 2022.

(51) Int. Cl. B65D 51/28; B65D 51/32; B65D 41/04; A45D 40/18

(52) U.S. Cl. CPC B65D 51/28; B65D 51/32; B65D 41/04; A45D 40/18

(57) ABSTRACT

Presented is a novel packaging for storage of freckles or similar cosmetic compositions along with an integrated toothpick. The packing specifically provides a novel cap portion that covers the receptacle/container holding the freckle or other similar cosmetic composition and at the same time facilitates storage of a toothpick such that the elongated pin portion of the toothpick gets securely stored within the elongated slot of the wand of the cap portion.

### CROSS-REFERENCE TO RELATED PATENT DOCUMENTS

This patent application claims the benefit of priority of U.S. Provisional Application No. 63/352,325 entitled “COMPACT, LEAKLESS, AND POWER-EFFICIENT PACKAGED TERMINAL AIR CONDITIONER (PTAC) WITH AN EVAPORATING ELEMENT FOR THE MELTWATER,” filed 15 Jun. 2022, which is hereby incorporated herein by reference in its entirety.

### TECHNICAL FIELD

The present invention relates to a freckle or similar cosmetic packaging that requires the use of tools such as toothpicks. Particularly the present invention discloses a novel packaging for storage of freckle or similar cosmetic compositions along with an integrated toothpick within a cap covering the receptacle holding the freckles or similar cosmetic compositions.

### BACKGROUND

The use of cosmetic products on a user's skin to create a “faux-freckle look” has become a new area of interest for the growing cosmetic industry. Typically, faux-freckle products are a bit difficult to be used because they require a steady hand to apply cosmetics properly to the uses skin. Lots of people use different tools (Eg. toothpicks) to create the look of faux freckles on the skin. Without the use of these tools usually, freckles appear unrealistic. Mostly, these tools are provided as a separate piece rather than as an integral part of the bottle/container holding the cosmetic/composition.

FIG. 1 shows a typical prior art packaging 10 for a freckle or similar cosmetic composition and a toothpick 16 separately provided with the packaging. The freckle or similar cosmetic composition is held within a container/bottle 12. A cap 13 with an integrated wand 14 provided to cover the opening of the bottle 12. As seen, one end of the wand 14 is attached to the interior of the cap 13 whereas the other end of the wand 14 is provided with bristles 15 with which one can apply cosmetic composition on the skin. The main concern with this type of traditional packaging for a freckle or similar cosmetic composition is that the tool (particularly a toothpick 16) is provided as a separate item within the packaging or with the bottle 12 holding the composition. This toothpick 16 has a tendency to get lost or get misplaced most of the time and the user needs to pay proper attention during use and has to safely store the same so that during the next uses of the cosmetic they can easily locate the toothpick.

The object of the present invention is to invent a novel packaging for a freckle or similar cosmetic composition that would integrate the toothpick within the packaging itself eliminating the need to carry the bottle with composition and toothpick separately.

### BRIEF SUMMARY

It is an object of the present invention to provide a novel packaging for freckles or similar cosmetic composition with a toothpick or similar tool integrated with the cap covering the receptacle holding the freckles or similar cosmetic composition.

It is another objective of the present invention to provide a novel packaging for freckles or similar cosmetic composition that's more compact and integrally includes a toothpick useful for creating the look of faux freckles on the skin.

It is another objective of the present invention to provide a novel packaging with a novel cap design configured to receive a toothpick therein which is useful for creating the look of faux freckles on the skin.

Embodiments of the present invention disclose a novel packaging for storage of freckles or similar cosmetic compositions along with an integrated toothpick. The packing specifically provides a novel cap portion that covers the receptacle/container holding the freckle or other similar cosmetic composition and at the same time facilitates storage of the toothpick such that the elongated pin portion of the toothpick gets securely stored within the elongated slot of the wand of the cap portion after uses.

According to an aspect of the present invention, the novel packaging (100) comprising: a receptacle (102) for storage of freckles or similar cosmetic composition therein, the receptacle (102) comprises a set of threads 102a provided at its neck; a cap portion (104) comprising a head (104c); a wand (104a) having a first end and a second end, the first end of the wand (104a) is attached underside the head (104c) and the second end of the wand (104a) carries bristles attached thereto, and wherein the head (104c) includes a centrally located slot (1041) that forms a passage to an elongated slot (104a′) formed along the length of the wand (104); and a collar (104d) adapted for receiving the head (104c), the collar (104d) further comprising a first set of engaging threads (104e), and a slot (104g) that gets inline and forms a continual passage with the centrally located slot (1041) and the elongated slot (104a′) during assembly; and a toothpick (106) having a head portion (106a) having a second set of engaging threads (106c) configured underside the head (106a), an elongated pin (106b) extending downwardly from the head portion (106a), and wherein the elongated pin (106b)c during assembly of the packaging passes through the slots (104f, 104g) and received within the elongated slot (104a′) of the wand (104a) of the cap portion (104).

According to another aspect of the present invention, the novel packaging (100) comprising: a receptacle (102) for storage of freckles or similar cosmetic composition therein, the receptacle (102) comprises a set of threads 102a provided at its neck; a cap portion (104) comprising a head (104c); a wand (104a) having a first end and a second end, the first end of the wand (104a) is attached underside the head (104c) and the second end of the wand (104a) carries bristles attached thereto, and wherein the head (104c) includes a centrally located slot (1041) that forms a passage to an elongated slot (104a′) formed along the length of the wand (104); and a toothpick (106) having a head portion (106a) having a second set of engaging threads (106c) configured underside the head (106a), an elongated pin (106b) extending downwardly from the head portion (106a), and wherein the elongated pin (106b)c during assembly of the packaging passes through the slot (104f) and received within the elongated slot (104a′) of the wand (104a) of the cap portion (104).

Various advantages and features of the present invention are described herein with specificity so as to make the present invention understandable to one of ordinary skill in the art, both with respect to how to practice the present invention and how to make the present invention.

### BRIEF DESCRIPTION OF THE DRAWINGS

The above set forth and other features of the present invention are made more apparent in the ensuing description of the preferred embodiments when read in conjunction with the attached drawings, wherein:

FIG. 1 shows a typical prior art packaging for freckles or similar cosmetic composition that involves the use of a toothpick or similar tool.

FIG. 2 shows a side view of a novel packaging for freckles or similar cosmetic composition with a toothpick integrated within a cap covering a receptacle holding the freckles or similar cosmetic composition, according to an exemplary embodiment.

FIG. 3 shows a cross-sectional view of the packaging of FIG. 2.

FIG. 4 shows an exploded view of the packaging of FIG. 2.

FIG. 5 shows a partial close-up view of the cap and the toothpick of FIG. 4, according to an exemplary embodiment.

FIG. 6 shows an exploded view of the packaging for freckles or similar cosmetic composition and the toothpick integrated within the cap, according to another exemplary embodiment.

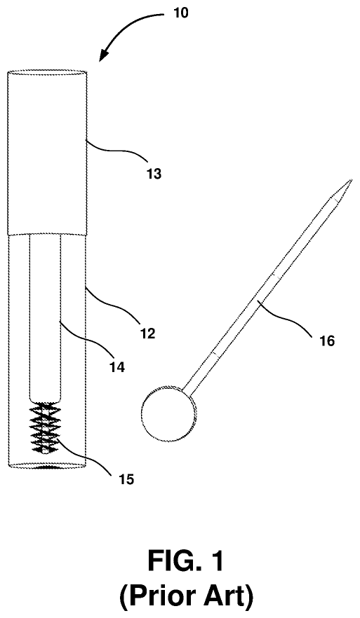

Identical reference numerals in the figures are intended to indicate like parts, although not every feature in every figure may be called out with a reference numeral.

### DETAILED DESCRIPTION

Certain terminology is used in the following description for reference only and is not limiting. Unless specifically set forth herein, the terms “a,” “an,” and “the” are not limited to one element, but instead should be read as meaning “at least one.” The terminology includes the words noted above, derivatives thereof, and words of similar import. Before describing the present invention in detail, it should be observed that the present invention utilizes a combination of components, which constitutes a packaging for storage of freckles or similar cosmetic compositions and includes an integrated toothpick within a cap. Accordingly, the components have been represented, showing only specific details that are pertinent for an understanding of the present invention so as not to obscure the disclosure with details that may be readily apparent to those with ordinary skill in the art having the benefit of the description herein. As required, the detailed embodiments of the present invention are disclosed herein. However, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The words “comprising”, “having”, “containing”, and “including”, and other forms thereof, are intended to be equivalent in meaning and be open-ended in that an item or items following any one of these words is not meant to be an exhaustive listing of such item or items or meant to be limited to only the listed item or items.

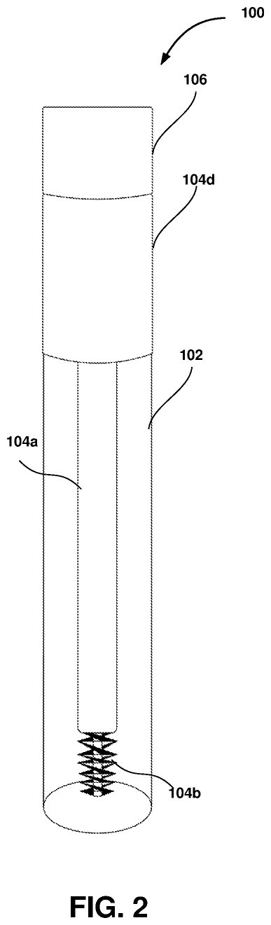

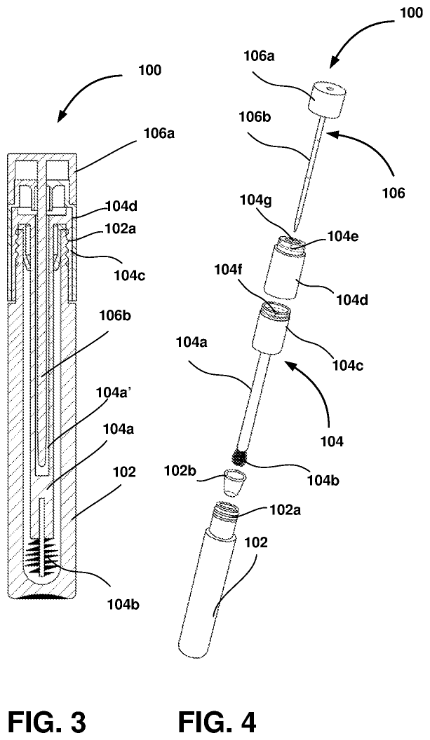

Referring to FIGS. 2-5, there is provided a novel packaging 100 for storage of freckle or similar cosmetic composition. The packaging 100 includes a receptacle or container 102. The receptacle 102 can be of any shape, for example, cylindrical, rectangular, square, tubular, and so on, and be made of different sizes depending upon the desired volume of composition that needs to be stored within the receptacle 102. The receptacle 102 may be made using transparent glass, plastic, acrylic, etc according to one embodiment. In another embodiment, receptacle 102 may be made using non-transparent material. As seen in FIG. 4, the receptacle 102 may have a set of threads 102a provided at its neck that helps the receptacle 102 engage to the cap 104. The cap 104 will have another set of threading provided underside (not seen) that would detachably engage with the threads 102a of the receptacle 102. The receptacle 102 may optionally be provided with a mouth shield 102b that would cover the opening of the receptacle 102. The mouth shield 102b may prevent or limit the loss of the composition if the receptacle 102 accidentally falls.

As is seen in FIG. 4, the packaging 100 further comprises the cap portion 104. The cap portion 104 includes a head 104c, and a wand 104a having a first end and a second end. The first end of the wand 104a is attached underside the head 104c and the second end of the wand 104a has bristles 104b attached thereto. The bristles 104b can of any type depending upon the cosmetic needs of the user. The wand 104a further comprises an elongated slot 104a′ formed along the length of the wand 104a. The wand 104a may be thicker or thinner depending upon the requirement. The elongated slot 104a′ may extend partially or fully along the length of the wand 104a. The head 104c may be made in different shapes that would complement the shape of the receptacle 102. For example, it is cylindrical in shape as shown. The head 104c at its top includes a centrally located slot 104f that forms a passage to the elongated slot 104a′ formed along the length of the wand 104.

Further as seen, the packaging 100 includes a collar 104d adapted for receiving the head 104c of the cap 104 during the assembly of the product. The collar 104d includes a first set of engaging threads 104e and a slot 104g that during assemblage gets inline and forms a continual passage with the centrally located slot 104f of the head 104c and the elongated slot 104a′ formed within the wand 104a. The first set of threads 104e of the collar 104d detachably engages with a head portion 106a of a toothpick 106.

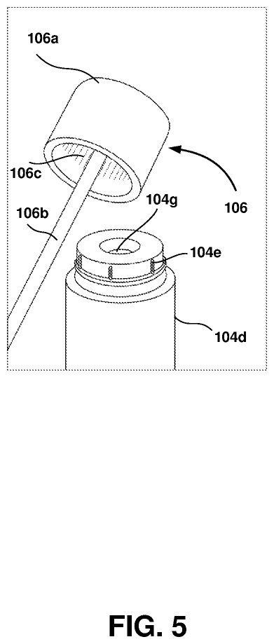

According to the embodiment, the packaging 100 includes a toothpick 106 having the head portion 106a having a second set of engaging threads 106c (FIG. 5) configured underside the head 106a. These threads 106c provided the underside of the head 106a of the toothpick 106 helps in engaging the head 106a with the threads 104e of the collar 104d of the cap 104. The toothpick 106 includes an elongated pin 106b extending downwardly from its head portion 106a. This elongated pin 106bd during the assembly of the packaging 100 passes through the slots 104f, 104g and gets received within the elongated slot 104a′ of the wand 104a of the cap portion 104.

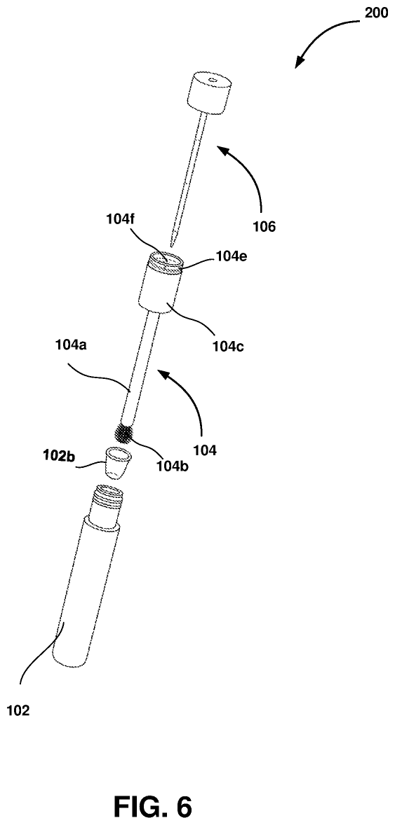

In another implementation 200, the use of collar 104d may be completely eliminated from the packaging as shown in FIG. 6. All of the components shown in FIG. 6 are similar to the elements presented and described with respect to FIGS. 2-5, except this embodiment shown in FIG. 6 does not show the use of any collar 104d rather, the head 104c of the cap portion 104 itself includes external threads 104e that facilitates engagement of the head 104c with the head portion 106a of the toothpick 106. Also, the elongated pin 106b of the toothpick 106 is just required to pass through the slot 104f to get into and retained within the elongated slot 04a′ of the wand 104a of the cap portion 104.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claim.

What is claimed is:

1. A novel packaging (100), comprising:
a receptacle (102) for storage of freckles or similar cosmetic composition therein, the receptacle (102) comprises a set of threads 102a provided at its neck;
a cap portion (104) comprising
a head (104c);
a wand (104a) having a first end and a second end, the first end of the wand (104a) is attached underside the head (104c) and the second end of the wand (104a) carries bristles attached thereto, and wherein the head (104c) includes a centrally located slot (1041) that forms a passage to an elongated slot (104a′) formed along the length of the wand (104); and
a collar (104d) adapted for receiving the head (104c), the collar (104d) further comprising a first set of engaging threads (104e), and a slot (104g) that gets inline and forms a continual passage with the centrally located slot (1041) and the elongated slot (104a′) during assembly; and
a toothpick (106) having a head portion (106a) having a second set of engaging threads (106c) configured underside the head (106a), an elongated pin (106b) extending downwardly from the head portion (106a), and wherein the elongated pin (106b)c during assembly of the packaging passes through the slots (104f, 104g) and received within the elongated slot (104a′) of the wand (104a) of the cap portion (104).

2. The novel packaging (100) of claim 1, wherein the receptacle (102) is at least cylindrical, rectangular, square, or tubular in shape.

3. The novel packaging (100) of claim 1, wherein the receptacle (102) is made using transparent material selected from a group consisting of glass, plastic, and acrylic.

4. The novel packaging (100) of claim 1, wherein the receptacle (102) is made using nontransparent material.

5. The novel packaging (100) of claim 1, wherein the receptacle (102) is provided with a mouth shield (102b) to cover an opening of the receptacle (102) and prevent or limit the loss of the freckles or similar cosmetic composition if the receptacle (102) accidentally falls off.

6. The novel packaging (100) of claim 1, wherein the elongated slot (104a′) extends partially or fully along the length of the wand (104a).

7. The novel packaging (100) of claim 1, wherein the head (104c) is shaped to complement the shape of the receptacle (102).

8. The novel packaging (100) of claim 1, wherein the head (104c) comprises a centrally located slot (104f) that serves as a passage for the elongated slot (104a′) formed along the length of the wand (104).

9. The novel packaging (100) of claim 1, wherein the first set of threads (104e) of the collar (104d) detachably engages with a head portion (106a) of the toothpick (106).

10. A novel packaging (100), comprising:
a receptacle (102) for storage of freckles or similar cosmetic composition therein, the receptacle (102) comprises a set of threads 102a provided at its neck;
a cap portion (104) comprising
a head (104c);
a wand (104a) having a first end and a second end, the first end of the wand (104a) is attached underside the head (104c) and the second end of the wand (104a) carries bristles attached thereto, and wherein the head (104c) includes a centrally located slot (1041) that forms a passage to an elongated slot (104a′) formed along the length of the wand (104); and
a toothpick (106) having a head portion (106a) having a second set of engaging threads (106c) configured underside the head (106a), an elongated pin (106b) extending downwardly from the head portion (106a), and wherein the elongated pin (106b)c during assembly of the packaging passes through the slot (104f) and received within the elongated slot (104a′) of the wand (104a) of the cap portion (104).
